(19) United States
(12) Patent Application Publication
(10) Pub. No.: US 2026/0074478 A1
(43) Pub. Date: Mar. 12, 2026

(54) CHARGING DOCK

(71) Applicants: Tyco Electronics Holdings (Bermuda) No. 7 Limited, Hamilton (BM); Tyco Electronics (Shanghai) Co., Ltd., Shanghai (CN)

(72) Inventors: Hengkang Wu, Dongguan (CN); David (Xinjie) Zhang, Shanghai (CN); Josh Jiang, Taipei (TW)

(73) Assignees: Tyco Electronics Holdings (Bermuda) No. 7 Limited, Hamilton (BM); Tyco Electronics (Shanghai) Co., Ltd., Shanghai (CN)

(21) Appl. No.: 19/319,994

(22) Filed: Sep. 5, 2025

(30) Foreign Application Priority Data
Sep. 6, 2024 (CN) 202411252283.9

(51) Int. Cl. H01R 25/16; H01R 4/02; H01R 12/71; H01R 13/405; H01R 13/6471; H01R 13/652; H01R 13/6586

(52) U.S. Cl. CPC H01R 25/168; H01R 4/023; H01R 12/714; H01R 13/405; H01R 13/6471; H01R 13/652; H01R 13/6586

(57) ABSTRACT

A grounding member includes a plurality of grounding terminals arranged in a row in a transverse direction and a connecting strip extending in the transverse direction and connected to one end of each of the plurality of grounding terminals. The grounding member is an integral stamped part.

### CROSS-REFERENCE TO RELATED APPLICATION

This application claims the benefit of the filing date under 35 U.S.C. § 119(a)-(d) of Chinese Patent Application No. 202411252283.9, filed on Sep. 6, 2024.

### FIELD OF THE INVENTION

The present invention relates to a grounding member, an electrical connection module including the grounding member and a connector including the electrical connection module.

### BACKGROUND OF THE INVENTION

A connector typically includes a retainer, a row of terminals retained in the retainer, and a row of cables soldered to rear ends of the row of terminals. The row of terminals include a plurality of grounding terminals and a plurality of pairs of signal terminals. Each pair of signal terminals is arranged between two adjacent grounding terminals. In order to improve the grounding shielding performance, the connector has a grounding strip which is in electrical contact with each of the grounding terminals, for achieving electrical interconnection of the plurality of grounding terminals. Existing connectors have the defects of poor grounding shielding effect and poor signal integrity.

### SUMMARY OF THE INVENTION

A grounding member includes a plurality of grounding terminals arranged in a row in a transverse direction and a connecting strip extending in the transverse direction and connected to one end of each of the plurality of grounding terminals. The grounding member is an integral stamped part.

### BRIEF DESCRIPTION OF THE DRAWINGS

Features of the present invention will become more apparent by describing in detail exemplary embodiments thereof with reference to the accompanying drawings, in which:

FIG. 1 shows an illustrative perspective view of a row of terminals of a connector according to an exemplary embodiment of the present invention;

FIG. 2 shows an illustrative perspective view of a grounding member of a connector according to an exemplary embodiment of the present invention;

FIG. 3 shows an illustrative view of soldering solder pads to top surfaces of solder portions of grounding terminals shown in FIG. 1;

FIG. 4 shows an illustrative view of a retainer being formed on a grounding member, signal terminals and the solder pads shown in FIG. 3 by injection molding;

FIG. 5 shows an illustrative view of soldering ground lines and signal lines of cables to grounding terminals and signal terminals shown in FIG. 4, respectively;

FIG. 6 shows an illustrative perspective view of a grounding member, signal terminals, solder pads and cables of a connector according to an exemplary embodiment of the present invention;

FIG. 7 shows an illustrative perspective view of an upper shield cover and a lower shield cover of a connector according to an exemplary embodiment of the present invention;

FIG. 8 shows an illustrative view of soldering an upper shield cover and a lower shield cover to the grounding terminals shown in FIG. 5;

FIG. 9 shows an illustrative perspective view of a grounding member, signal terminals, solder pads, cables, an upper shield cover and a lower shield cover of a connector according to an exemplary embodiment of the present invention;

FIG. 10 shows a transverse sectional view of an electrical connection module shown in FIG. 9;

FIG. 11 shows an illustrative view of an injection-molded body being formed on the electrical connection module shown in FIG. 8 by injection molding;

FIG. 12 shows an illustrative perspective view of an upper shield member and a lower shield member of a connector according to an exemplary embodiment of the present invention; and

FIG. 13 shows an illustrative view of soldering an upper shield member and a lower shield member to cantilever portions of grounding terminals shown in FIG. 11.

### DETAILED DESCRIPTION

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

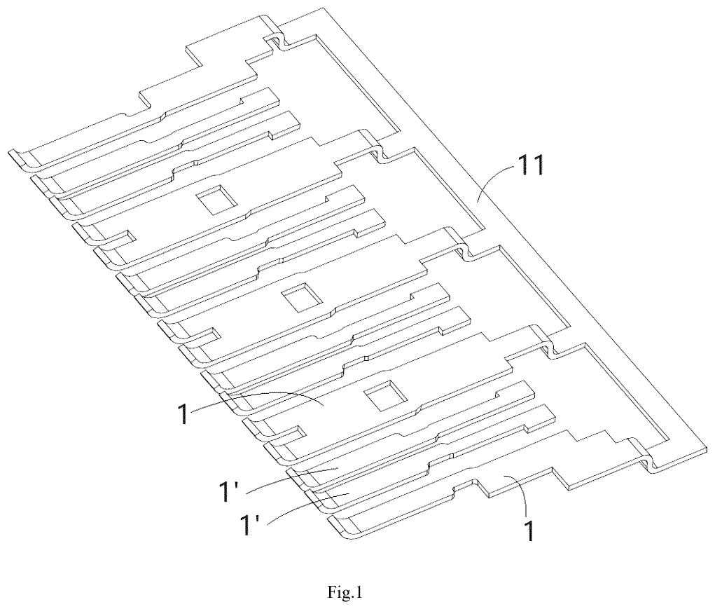

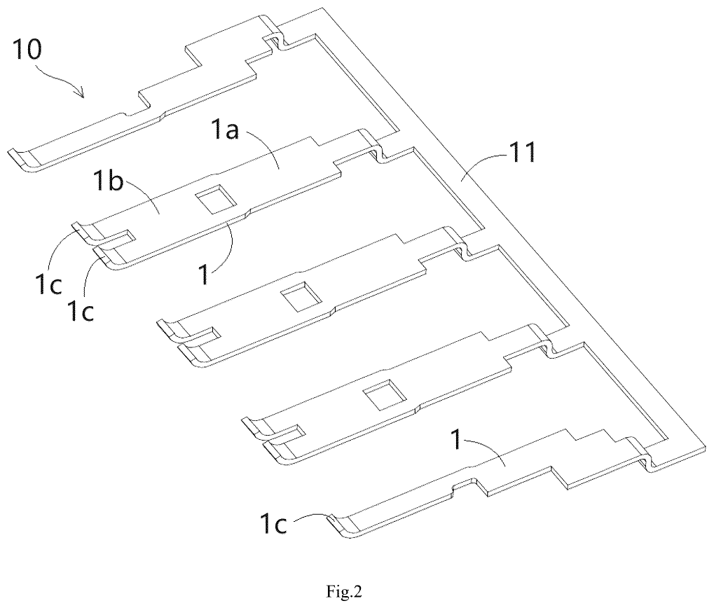

As shown in FIGS. 1 and 2, in an exemplary embodiment of the present invention, a grounding member 10 is disclosed. The grounding member 10 includes a plurality of grounding terminals 1 and a connecting strip 11. The plurality of grounding terminals 1 are arranged in a row in a transverse direction. The connecting strip 11 extends in the transverse direction and is connected to one end of each of the plurality of grounding terminals 1. The grounding member 10 is an integral stamped part.

As shown in FIGS. 1 and 2, in the illustrated embodiment, two adjacent grounding terminals 1 are spaced apart by a predetermined distance in the transverse direction to allow a pair of signal terminals (differential terminal pair) l′ to be arranged between the two adjacent grounding terminals 1. In the illustrated embodiment, each of the grounding terminals 1 extends in a longitudinal direction and has a front end and a rear end opposite each other in the longitudinal direction. The connecting strip 11 is connected to the rear ends of the plurality of grounding terminals 1.

As shown in FIGS. 1 and 2, in the illustrated embodiment, a contact clastic tab 1c is formed at the front end of the grounding terminal 1, and the contact elastic tab 1c is configured to make electrical contact with a contact pad on a circuit board or a mating terminal of a mating connector. In the illustrated embodiment, the outermost two grounding terminals 1 of the row of grounding terminals 1 each have a single contact elastic tab 1c for electrical contact with a single contact pad or a single mating terminal. The other grounding terminals 1 of the row of grounding terminals 1 other than the outermost two grounding terminals 1 each have two contact elastic tabs 1c arranged side by side for electrical contact with two contact pads or two mating terminals, respectively.

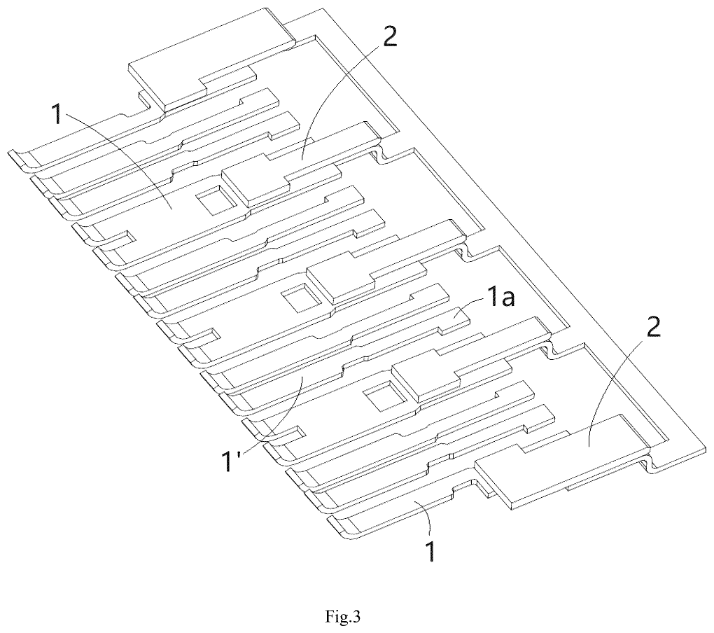

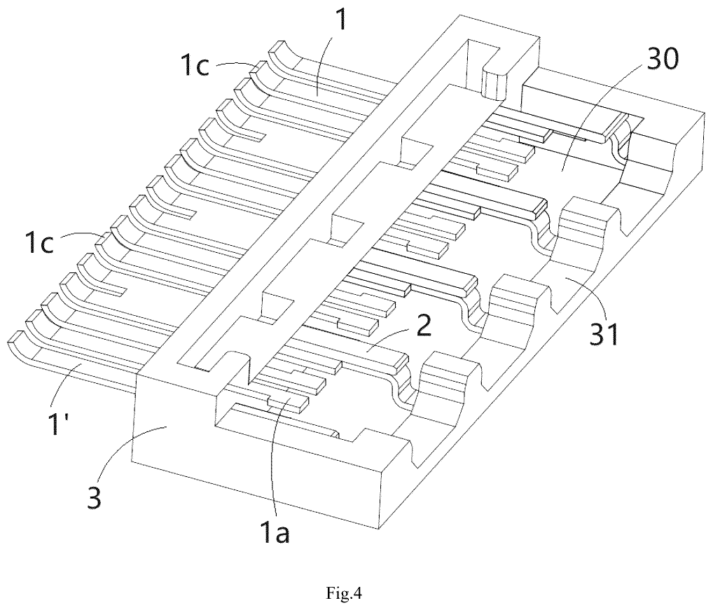

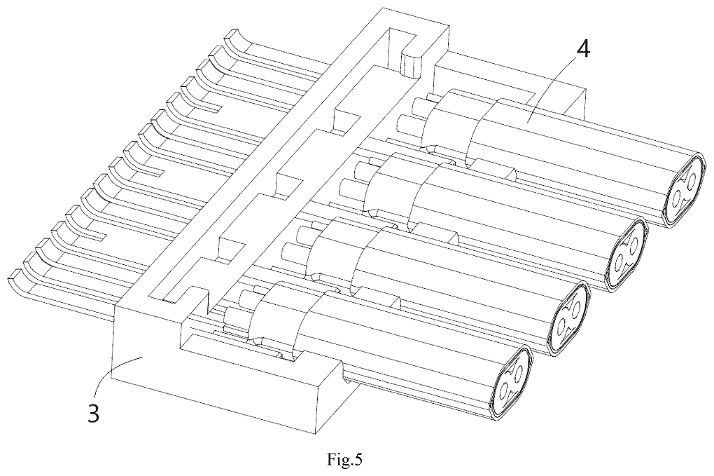

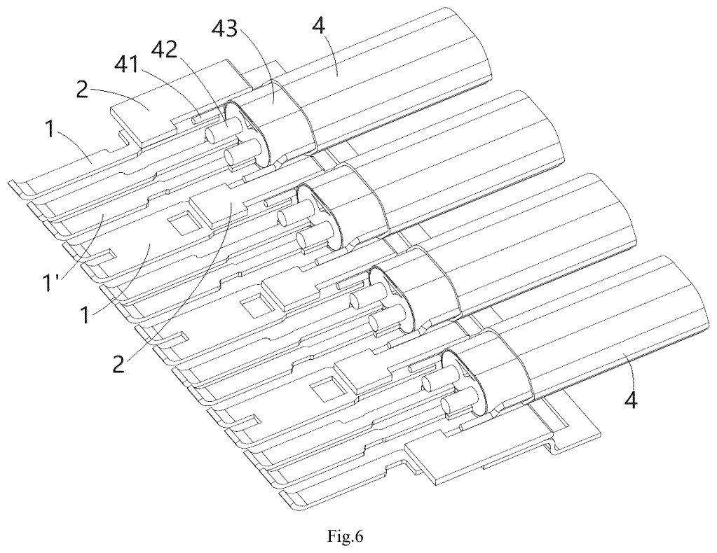

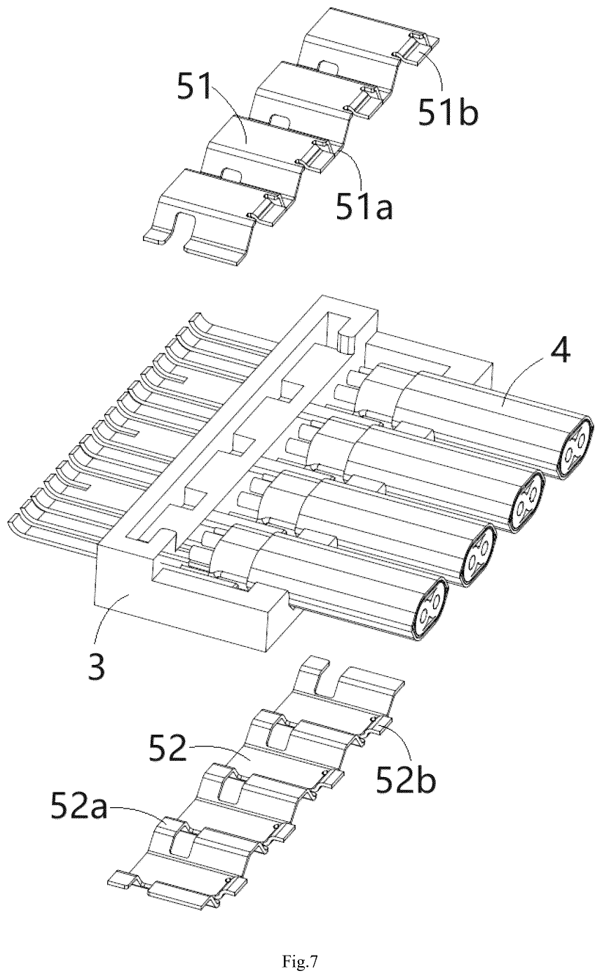

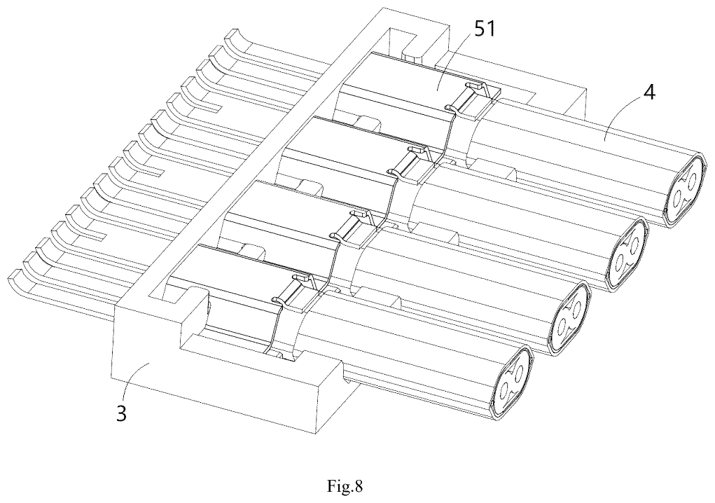

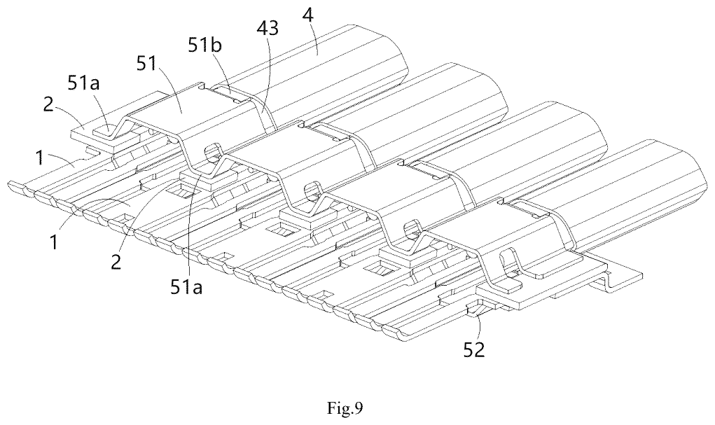

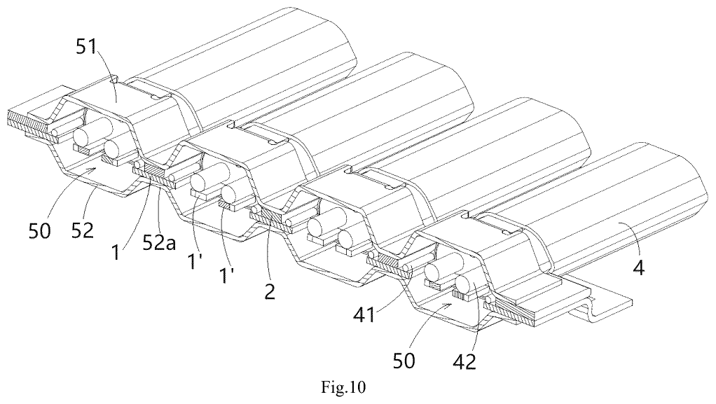

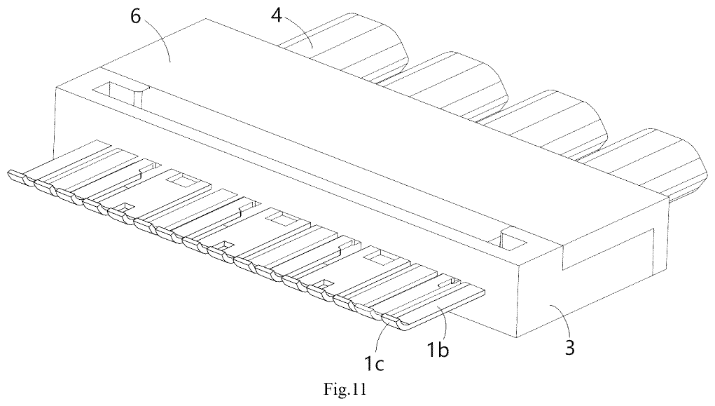

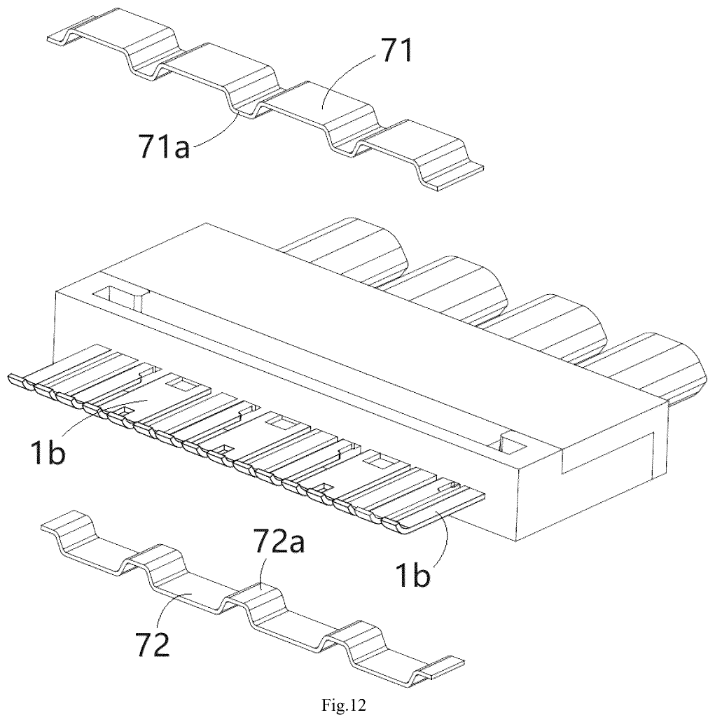

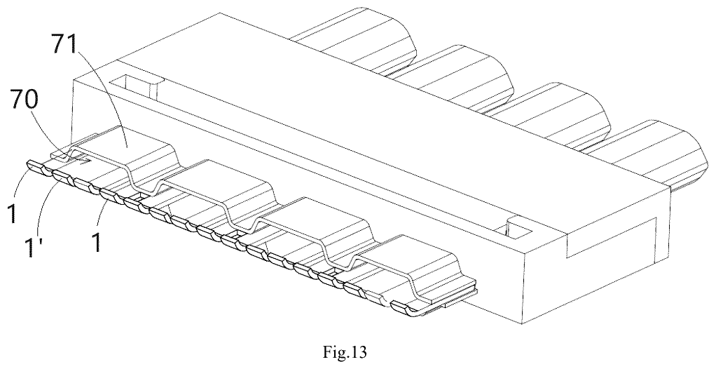

FIG. 3 shows an illustrative view of soldering solder pads to top surfaces of solder portions 1a of grounding terminals 1 shown in FIG. 1; FIG. 4 shows an illustrative view of a retainer 3 being formed on a grounding member 10, signal terminals 1′ and the solder pads 2 shown in FIG. 3 by means of injection molding; FIG. 5 shows an illustrative view of soldering ground lines 41 and signal lines 42 of cables 4 to grounding terminals 1 and signal terminals 1′ shown in FIG. 4, respectively; FIG. 6 shows an illustrative perspective view of a grounding member 10, signal terminals 1′, solder pads 2 and cables 4 of a connector according to an exemplary embodiment of the present invention; FIG. 7 shows an illustrative perspective view of an upper shield cover 51 and a lower shield cover 52 of a connector according to an exemplary embodiment of the present invention; FIG. 8 shows an illustrative view of soldering an upper shield cover 51 and a lower shield cover 52 to the grounding terminals 1 shown in FIG. 5; FIG. 9 shows an illustrative perspective view of a grounding member 10, signal terminals 1′, solder pads 2, cables 4, an upper shield cover 51 and a lower shield cover 52 of a connector according to an exemplary embodiment of the present invention; FIG. 10 shows a transverse sectional view of an electrical connection module shown in FIG. 9; FIG. 11 shows an illustrative view of an injection-molded body 6 being formed on the electrical connection module shown in FIG. 8 by means of injection molding; FIG. 12 shows an illustrative perspective view of an upper shield member 71 and a lower shield member 72 of a connector according to an exemplary embodiment of the present invention; and FIG. 13 shows an illustrative view of soldering an upper shield member 71 and a lower shield member 72 to cantilever portions 1b of grounding terminals 1 shown in FIG. 11.

As shown in FIGS. 1 to 13, in another exemplary embodiment of the present invention, an electrical connection module is disclosed. The electrical connection module includes: a grounding member 10, a plurality of pairs of signal terminals 1′ and a retainer 3. Each pair of signal terminals 1′ is arranged side by side between two adjacent grounding terminals 1 of the grounding member 10. The retainer 3 is configured to retain the grounding member 10 and the plurality of pairs of signal terminals 1′. Part of the grounding terminals 1 and the signal terminals 1′ is embedded in the retainer 3, and a connecting strip 11 of the grounding member 10 is embedded in the retainer 3.

In the illustrated embodiment, the retainer 3 is an injection-molded part directly injection-molded on the grounding member 10 and the plurality of pairs of signal terminals 1′, such that the grounding member 10, the plurality of pairs of signal terminals 1′ and the retainer 3 form an integral part.

As shown in FIG. 11, in the illustrated embodiment, the grounding terminals 1 and the signal terminals 1′ each have a cantilever portion 1b protruding from a front side of the retainer 3. A contact clastic tab 1c is formed at a tail end of the cantilever portion 1b, and the contact elastic tab 1c is configured to make electrical contact with a contact pad on a circuit board or a mating terminal of a mating connector.

As shown in FIG. 4, in the illustrated embodiment, a window 30 is formed on the retainer 3. The grounding terminals 1 and the signal terminals 1′ each have a solder portion 1a exposed from the window 30 of the retainer 3. The solder portion 1a of the grounding terminal 1 is configured to be soldered to a ground line 41 of a cable 4, and the solder portion 1a of the signal terminal 1′ is configured to be soldered to a signal line 42 of the cable 4.

As shown in FIGS. 5 and 6, in the illustrated embodiment, the electrical connection module includes a plurality of cables 4. Each of the plurality of cables 4 has two ground lines 41 and a pair of signal lines 42 between the two ground lines 41. The two ground lines 41 of the cable 4 are soldered to top surfaces of the solder portions 1a of two adjacent grounding terminals 1 respectively, and the pair of signal lines 42 of the cable 4 are soldered to top surfaces of the solder portions 1a of the pair of signal terminals 1′ respectively.

As shown in FIG. 4, in the illustrated embodiment, a plurality of positioning recesses 31 are formed on the top of a rear side of the retainer 3, and the plurality of cables 4 are positioned in the plurality of positioning recesses 31 of the retainer 3 respectively, as shown in FIG. 5.

As shown in FIGS. 3 and 6, in the illustrated embodiment, the electrical connection module further includes a plurality of solder pads 2. The plurality of solder pads 2 have a predetermined thickness and are soldered to the top surfaces of the solder portions 1a of the plurality of grounding terminals 1 respectively. The solder pad 2 protrudes from the top surface of the solder portion 1a of the grounding terminal 1 by a predetermined height for defining a solder position of the ground line 41 located next thereto.

As shown in FIGS. 7-10, in the illustrated embodiment, the electrical connection module further includes an upper shield cover 51 disposed in a top opening of the window 30 of the retainer 3. The upper shield cover 51 has a plurality of upper solder protrusions 51a and a plurality of upper solder tail lugs 51b. The plurality of upper solder protrusions 51a are soldered to top surfaces of the plurality of solder pads 2 respectively, and the plurality of upper solder tail lugs 51b are soldered to exposed shield layers of the plurality of cables 4 respectively.

As shown in FIGS. 7 and 9, in the illustrated embodiment, the electrical connection module further includes a lower shield cover 52 disposed in a bottom opening of the window 30 of the retainer 3. The lower shield cover 52 has a plurality of lower solder protrusions 52a and a plurality of lower solder tail lugs 52b. The plurality of lower solder protrusions 52a are soldered to bottom surfaces of the solder portions 1a of the plurality of grounding terminals 1 respectively, and the plurality of lower solder tail lugs 52b are soldered to the exposed shield layers of the plurality of cables 4 respectively.

As shown in FIG. 10, in the illustrated embodiment, a plurality of shield cavities 50 are defined between the upper shield cover 51 and the lower shield cover 52, and two adjacent shield cavities 50 are separated from each other. The two ground lines 41 and the pair of signal lines 42 of each cable 4 are accommodated in a corresponding shield cavity 50 such that two adjacent cables 4 are separated from each other. The solder portions 1a of each pair of signal terminals 1′ are accommodated in a corresponding shield cavity 50 such that the solder portions 1a of the two adjacent two pairs of signal terminals 1′ are separated from each other. As a result, the grounding shielding effect and signal integrity can be improved.

As shown in FIG. 11, in the illustrated embodiment, the electrical connection module further includes an injection-molded body 6. The injection-molded body 6 is injection-molded in the window 30 of the retainer 3 to fill the window 30 of the retainer 3. The plurality of cables 4, the plurality of upper shield covers 51 and the plurality of lower shield covers 52 are retained to the retainer 3 by the injection-molded body 6.

As shown in FIG. 12, in the illustrated embodiment, the electrical connection module further includes an upper shield member 71 and a lower shield member 72. The upper shield member 71 is located above cantilever portions 1b of the plurality of grounding terminals 1 and the plurality of pairs of signal terminals 1′ and has a plurality of upper solder portions 71a soldered to top surfaces of the cantilever portions 1b of the plurality of grounding terminals 1 respectively. The lower shield member 72 is located below the cantilever portions 1b of the plurality of grounding terminals 1 and the plurality of pairs of signal terminals 1′ and has a plurality of lower solder portions 72a soldered to bottom surfaces of the cantilever portions 1b of the plurality of grounding terminals 1 respectively.

As shown in FIG. 13, in the illustrated embodiment, a plurality of shield chambers 70 are defined between the upper shield member 71 and the lower shield member 72. Two adjacent shield chambers 70 are separated from each other, and the cantilever portions 1b of each pair of signal terminals 1′ are accommodated in a corresponding shield chamber 70 such that the cantilever portions 1b of two adjacent pairs of signal terminals 1′ are separated from each other. As a result, the grounding shielding effect and signal integrity can further be improved.

In another exemplary embodiment of the present invention, a connector is disclosed. The connector includes a housing and the aforementioned electrical connection module. The aforementioned electrical connection module is mounted into the housing. In the illustrated embodiment, the connector may include a plurality of electrical connection modules mounted side by side in the housing.

In the aforementioned exemplary embodiments according to the present invention, the connector has excellent grounding shielding effect and signal integrity, and the signal integrity may reach up to 224 G.

It should be appreciated for those skilled in this art that the above embodiments are intended to be illustrative, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and preceded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

1. A grounding member, comprising:
a plurality of grounding terminals arranged in a row in a transverse direction; and
a connecting strip extending in the transverse direction and connected to one end of each of the plurality of grounding terminals, the grounding member is an integral stamped part.

2. The grounding member according to claim 1, wherein a pair of adjacent grounding terminals of the plurality of grounding terminals are spaced apart by a predetermined distance in the transverse direction to allow a pair of signal terminals to be arranged between the pair of adjacent grounding terminals.

3. The grounding member according to claim 1, wherein each of the grounding terminals extends in a longitudinal direction and has a front end and a rear end opposite each other in the longitudinal direction, the connecting strip is connected to the rear ends of the plurality of grounding terminals.

4. The grounding member according to claim 3, wherein a contact elastic tab is formed at the front end of each of the grounding terminals, the contact elastic tab electrically contacts a contact pad on a circuit board or a mating terminal of a mating connector.

5. The grounding member according to claim 4, wherein an outermost pair of grounding terminals of the row of grounding terminals each have a single contact elastic tab for electrical contact with a single contact pad or a single mating terminal, a plurality of other grounding terminals of the row of grounding terminals other than the outermost pair of grounding terminals each have two contact elastic tabs arranged side by side for electrical contact with two contact pads or two mating terminals, respectively.

6. An electrical connection module, comprising:
a grounding member including a plurality of grounding terminals arranged in a row in a transverse direction, and a connecting strip extending in the transverse direction and connected to one end of each of the plurality of grounding terminals, the grounding member is an integral stamped part;
a plurality of pairs of signal terminals, each pair of signal terminals being arranged side by side between a pair of adjacent grounding terminals of the plurality of grounding terminals; and
a retainer retaining the grounding member and the plurality of pairs of signal terminals, a part of each of the grounding terminals and the signal terminals is embedded in the retainer, the connecting strip of the grounding member is embedded in the retainer.

7. The electrical connection module according to claim 6, wherein the retainer is an injection-molded part directly injection-molded on the grounding member and the plurality of pairs of signal terminals, the grounding member, the plurality of pairs of signal terminals, and the retainer form an integral part.

8. The electrical connection module according to claim 6, wherein the grounding terminals and the signal terminals each have a cantilever portion protruding from a front side of the retainer, a contact elastic tab is formed at a tail end of the cantilever portion, the contact elastic tab electrically contacts a contact pad on a circuit board or a mating terminal of a mating connector.

9. The electrical connection module according to claim 8, wherein a window is formed on the retainer, the grounding terminals and the signal terminals each have a solder portion exposed from the window of the retainer, the solder portion of the grounding terminal is soldered to a ground line of a cable, and the solder portion of the signal terminal is soldered to a signal line of the cable.

10. The electrical connection module according to claim 9, further comprising a plurality of cables each having a pair of ground lines and a pair of signal lines between the pair of ground lines, the pair of ground lines of the cable are soldered to a pair of top surfaces of the solder portions of two adjacent grounding terminals respectively, and the pair of signal lines of the cable are soldered to top surfaces of the solder portions of the pair of signal terminals respectively.

11. The electrical connection module according to claim 10, wherein a plurality of positioning recesses are formed on a top of a rear side of the retainer, the plurality of cables are respectively positioned in the plurality of positioning recesses of the retainer.

12. The electrical connection module according to claim 10, further comprising a plurality of solder pads having a predetermined thickness and respectively soldered to the top surfaces of the solder portions of the plurality of grounding terminals, the solder pad protrudes from the top surface of the solder portion of the grounding terminal by a predetermined height for defining a solder position of the ground line located next thereto.

13. The electrical connection module according to claim 12, further comprising an upper shield cover disposed in a top opening of the window of the retainer, the upper shield cover includes:
a plurality of upper solder protrusions respectively soldered to top surfaces of the plurality of solder pads respectively; and
a plurality of upper solder tail lugs respectively soldered to a plurality of exposed shield layers of the plurality of cables.

14. The electrical connection module according to claim 13, further comprising a lower shield cover disposed in a bottom opening of the window of the retainer, the lower shield cover includes:
a plurality of lower solder protrusions respectively soldered to bottom surfaces of the solder portions of the plurality of grounding terminals; and
a plurality of lower solder tail lugs respectively soldered to the plurality of exposed shield layers of the plurality of cables.

15. The electrical connection module according to claim 14, wherein a plurality of shield cavities are defined between the upper shield cover and the lower shield cover, and a pair of adjacent shield cavities of the plurality of shield cavities are separated from each other, the pair of ground lines and the pair of signal lines of each cable are accommodated in a corresponding shield cavity such that two adjacent cables are separated from each other, the solder portions of each pair of signal terminals are accommodated in a corresponding shield cavity such that the solder portions of the adjacent pairs of signal terminals are separated from each other.

16. The electrical connection module according to claim 15, further comprising an injection-molded body injection-molded in the window of the retainer to fill the window of the retainer, the plurality of cables, the upper shield cover, and the lower shield cover are retained to the retainer by the injection-molded body.

17. The electrical connection module according to claim 8, further comprising:
an upper shield member located above the cantilever portions of the plurality of grounding terminals and the plurality of pairs of signal terminals and having a plurality of upper solder portions respectively soldered to top surfaces of the cantilever portions of the plurality of grounding terminals; and
a lower shield member located below the cantilever portions of the plurality of grounding terminals and the plurality of pairs of signal terminals and having a plurality of lower solder portions respectively soldered to bottom surfaces of the cantilever portions of the plurality of grounding terminals.

18. The electrical connection module according to claim 17, wherein a plurality of shield chambers are defined between the upper shield member and the lower shield member, a pair of adjacent shield chambers are separated from each other, and the cantilever portions of each pair of signal terminals are accommodated in a corresponding shield chamber such that the cantilever portions of two adjacent pairs of signal terminals are separated from each other.

19. A connector, comprising:
a housing; and
an electrical connection module mounted in the housing, the electrical connection includes:
a grounding member having a plurality of grounding terminals arranged in a row in a transverse direction, and a connecting strip extending in the transverse direction and connected to one end of each of the plurality of grounding terminals, the grounding member is an integral stamped part;
a plurality of pairs of signal terminals, each pair of signal terminals being arranged side by side between a pair of adjacent grounding terminals of the plurality of grounding terminals; and
a retainer retaining the grounding member and the plurality of pairs of signal terminals, a part of each of the grounding terminals and the signal terminals is embedded in the retainer, the connecting strip of the grounding member is embedded in the retainer.

20. The connector according to claim 19, wherein the electrical connection module is one of a plurality of electrical connection modules mounted side by side in the housing.
